(19) United States
(12) Patent Application Publication
(10) Pub. No.: US 2005/0226501 A1
(43) Pub. Date: Oct. 13, 2005

(54) Compressing and decompressing image of a mobile communication terminal

(75) Inventor: Sun-Hwan An, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/104,344

(22) Filed: Apr. 11, 2005

(30) Foreign Application Priority Data
Apr. 13, 2004 (KR) 10-2004-0025525

(51) Int. Cl. G06K 9/00; G06K 9/36

(52) U.S. Cl. 382/166; 382/232

(57) ABSTRACT

An image compression method comprising counting number of pixels of at least a first color in an image comprising a plurality of pixels, wherein each of the plurality of pixels has a first identification code of a first size; assigning a second identification code to pixels of at least the first color such that the second identification code is smaller in size than the first identification code, wherein number of pixels of at least the first color is greater than a first threshold. At least the first identification code comprises an identifier distinguishing the first identification code from the second identification code.

### CROSS-REFERENCE TO RELATED APPLICATIONS

Pursuant to 35 U.S.C. § 119(a), this application claims the benefit of earlier filing date and right of priority to Korean Application No. 25525/2004 filed on Apr. 13, 2004, the contents of which is hereby incorporated by reference herein in its entirety.

### BACKGROUND OF THE INVENTION

1. Field of the Invention

The present invention relates to image compression and, more particularly, to a method for compressing and decompressing an image of a mobile communication system.

2. Description of the Related Art

A mobile communication terminal based on a text or a black and white screen includes a very small amount of display information, so it has a very small memory region allocated for the display information. Recently, however, as mobile communication terminals start implementing 4096 colors and 65000 colors, display information increasingly occupies the memory region, and accordingly, data storage capacity of the memory of the mobile communication terminals becomes larger.

Assuming that a mobile communication terminal can implement 65000 colors and display an image of 128 pixels in width and length, the total number of pixels of the images expressed by the mobile communication terminal is 16384 (128×128) and colors of each pixel need to be expressed by more than 16 bits of data. As such, size of one image file stored in the memory of the mobile communication terminal can exceed 32 K bytes. Particularly, if the image information (or pixel information) of such size is not compressed, a large area of memory space is required.

Image compression algorithms such as Run length, Huffman coding, LAW or a file compression algorithm of a GIF (Graphics Interchange Format) or a JPG (Joint Photographic Groups) format can be used. Different compression algorithms are employed according to the type of terminals or terminal manufacturers.

The above described related art image compression methods have a problem in that since information of every pixel is compressed, load amount in decompressing the compressed information increases and a display speed is slow. In addition, file compression algorithms such as the GIF or the JPG have a problem of damaging an original image. Especially, in case of the GIF, color expression is limited to 256 colors, failing to sufficiently utilize the LCD (Liquid Crystal Display) implementing various colors (4096 colors or 65000 colors).

A method and system is needed that can overcome the above problems.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. To achieve these and other advantages and in accordance with the purpose of the present invention, as embodied and broadly described, an image compression method is provided.

In accordance with one embodiment of the invention, the method comprises counting number of pixels of at least a first color in an image comprising a plurality of pixels, wherein each of the plurality of pixels has a first identification code of a first length identifying color of each pixel; assigning a second identification code to pixels of at least the first color such that the second identification is shorter in length than the first identification code, wherein number of pixels of at least the first color is greater than a first threshold.

At least the first identification code comprises an identifier distinguishing the first identification code from the second identification code. In one embodiment, the image compression method comprises including a data structure comprising cross-references between the first and second identification codes and the plurality of pixels in the image.

In accordance with another aspect of the invention, a method for decompressing a compressed image of a mobile communication terminal comprises detecting a look-up table and color information of pixels from a compressed image file. Color information of each pixel is checked and if a color identification code of a corresponding pixel has been newly assigned, a corresponding original identification code is searched from the look-up table and stored in a display buffer.

The color of each pixel is displayed on a screen with reference to the information stored in the buffer. The storing comprises checking a code discrimination bit included in color information of each pixel to determine whether a color identification code of a corresponding pixel is a new identification code or an origination identification code.

The method for decompressing a compressed image of a mobile communication terminal further comprises checking color information of each pixel. If the color identification code is the original identification code of the corresponding pixel, the identification code is stored as it is in the buffer.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

The invention will be described in detail with reference to the following drawings in which like reference numerals refer to like elements wherein.

FIG. 1 is a flow chart of an image compression method in accordance with one embodiment of the present invention.

FIG. 2 is a flow chart of a method for decompressing a compressed image in accordance with one embodiment of the present invention.

FIG. 3 illustrates the construction of image data stored in an image file in accordance with one embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

The present invention implements an image compressing method in which a storage code of a small size is newly assigned to a color with high presentation frequency and an original identification code is assigned as it is to a color with low presentation frequency in an image and then stored.

In accordance with one embodiment, a mobile communication terminal comprises a high resolution color LCD, for example, implementing 65000 colors and processes an image of a size of 16×16 pixels in width and length, for example. In one embodiment, the image consists of 6 colors (A, B, C, D, E and F), for example.

For storing the image, the mobile communication terminal checks color information of pixels constituting an image to obtain presentation frequency of each color (A, B, C, D, E and F). Presentation frequency for a color is the number of pixels having the corresponding color (e.g., A, B, C, D, E and F). Then, the mobile communication terminal assigns a new identification code (‘storage code’) to colors presented in pixels equal to or greater than a reference number (e.g., 50) (‘frequently presented colors’).

TABLE 1

| color | Identification code | Number of pixels |
|---|---|---|
| A | Ox0000 | 50 |
| B | Ox000f | 25 |
| E | Oxff00 | 70 |
| D | Ox0ff0 | 5 |
| C | Ox00ff | 6 |
| F | Oxffff | 100 |

Table 1 illustrates an exemplary color assignment table, in accordance with one embodiment. In Table 1, a different 2-bit storage code is assigned to colors A, E and F with presentation frequency equal to or greater than the reference value (e.g., 50). A length of the storage code is determined according to the number of frequently presented colors. For example, if there are four frequently presented colors, the length of the storage code can be 2 bits (00, 01, 10, 11). If there are five frequently presented colors, 3 bits (000, 001, 010, 011, 100) can be enough for the length of the storage code. The above reference values may vary and can be determined by a user or a system, depending on implementation.

Table 2 shows sizes of storage codes according to the number of frequently presented colors, in accordance to an exemplary embodiment.

TABLE 2

| The number of frequently | Sizes of storage |
|---|---|
| presented colors | codes |
| 1 or 2 | 1 bit |
| 3 or 4 | 2 bit |
| 5˜8 | 3 bit |
| 9˜16 | 4 bit |
| . | . |
| . | . |
| . | . |

When analysis for the color information of pixels is completed, the mobile communication terminal assigns a new, for example, 2-bit storage code to pixels with frequently presented colors, instead of their original color identification codes. Meanwhile, for the less frequently presented colors, the mobile communication terminal maintains the original color identification code for each pixel.

Table 3 is a look-up table showing original identification codes and storage codes of frequently presented colors (A, E and F).

TABLE 3

| Frequently presented | Identification | Storage code |
|---|---|---|
| colors | code | (binary) |
| A | Ox0000 | 0 (‘00’) |
| E | Oxff00 | 1 (‘01’) |
| F | Oxffff | 2 (10’) |

When the mobile communication terminal stores color information of each pixel in the image file, it also stores the look-up table. Thus, when the mobile communication terminal decompresses data of the image file, it decompresses color information of each pixel stored in the image file with reference to the look-up table.

In the present invention, in order to determine whether an identification code stored in each pixel is an original color identification code or a storage code of a corresponding pixel, a code discrimination bit (1 or 0) is added in front of the color information (e.g., identification code or storage code). If the code discrimination bit is ‘0’ for example, the following color information is the original identification code, and if the code discrimination bit is ‘1’ for example, the following color information is the new storage code (e.g., 2 bits).

Table 4 shows a comparison between a binary code of each color stored without application of a compression algorithm and a binary code of each color stored according to a compression algorithm of the present invention.

TABLE 4

| | | Binary code of each color stored |
|---|---|---|
| | Binary code of each | according to a compression |
| | color stored without | algorithm of the present invention |
| | application of a | (code discrimination bit + |
| Colors | compression algorithm | storage code (identification code) |
| A | “0000 0000 0000 0000” | “1 + 00” |
| B | “0000 0000 0000 1111” | “0 + 0000 0000 0000 1111” |
| C | “1111 1111 0000 0000” | “1 + 01” |
| D | “0000 1111 1111 0000” | “0 + 0000 1111 1111 0000” |
| E | “0000 0000 1111 1111” | “0 + 0000 0000 1111 1111” |
| F | “1111 1111 1111 1111” | “1 + 10” |

As noted in Table 4, when the compression algorithm in accordance with the present invention is applied, colors with high presentation frequency (e.g., the frequently presented colors) requires a smaller storage space (e.g., 3 bits) while colors with low presentation frequency require a larger storage space (e.g., 17 bits).

Although it may vary according to an image, typically the frequently presented colors account for approximately 10-20% of the entire colors that are presented in 80% of the entire pixels. Thus, a compression rate of the algorithm of the present invention can be quite high in such circumstances.

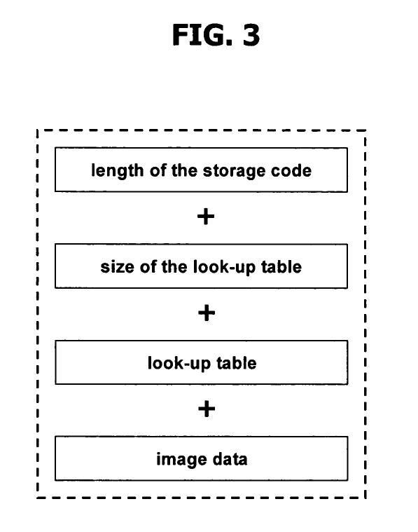

Referring to FIG. 3, an exemplary stored image data comprises ‘length of the storage code’+‘size of the look-up table’+‘look-up table’+‘image data’. The image data is the color information of each pixel. An exemplary storage form is shown in Table 4.

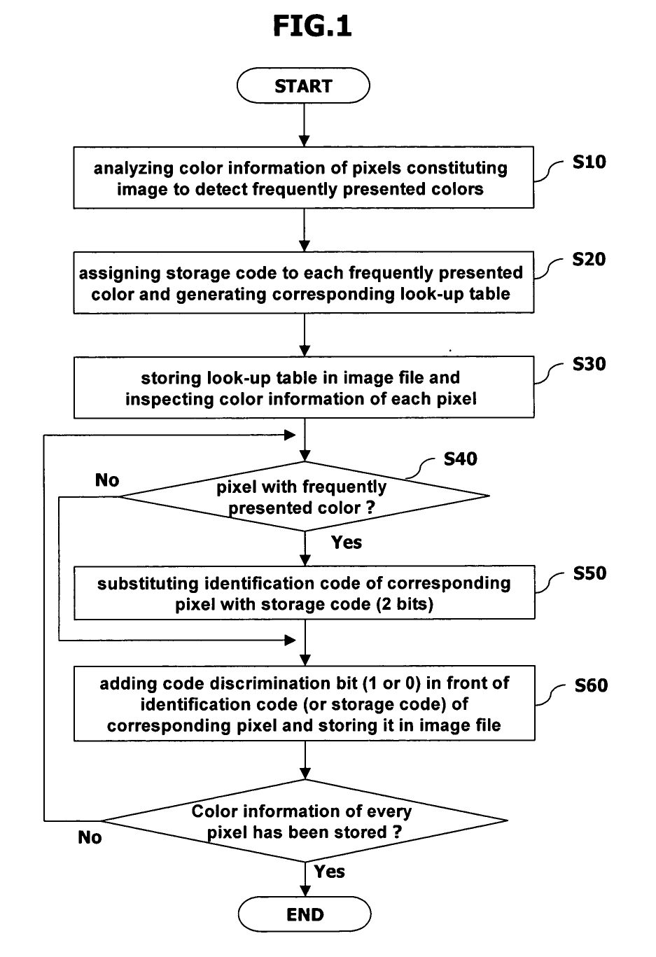

Referring to FIG. 1, to store an image, the mobile communication terminal analyzes color information of pixels constituting the image. The mobile communication terminal inspects each presentation frequency of each color to detect frequently presented colors (S10). The mobile communication terminal assigns a different storage code to each frequently presented color as detected and then generates a look-up table as shown in Table 3 (S20).

Thereafter, the mobile communication terminal stores the look-up table and color information of one or more pixels in a file according to the compression algorithm of the present invention (S30˜S60). The construction of the data stored in the image file in this case is as shown in FIG. 3, for example.

When the mobile communication terminal stores the color information of pixels, if a color of a pixel is a frequently presented color, the mobile communication terminal stores a storage code (e.g., 2 bits) assigned to the corresponding frequently presented color. If the color of the pixel is not the frequently presented color, the mobile communication terminal stores an original identification code (e.g., 16 bits) of the corresponding color. And then, the mobile communication terminal adds a code discrimination bit (1 or 0) in front of the stored storage code of the identification code.

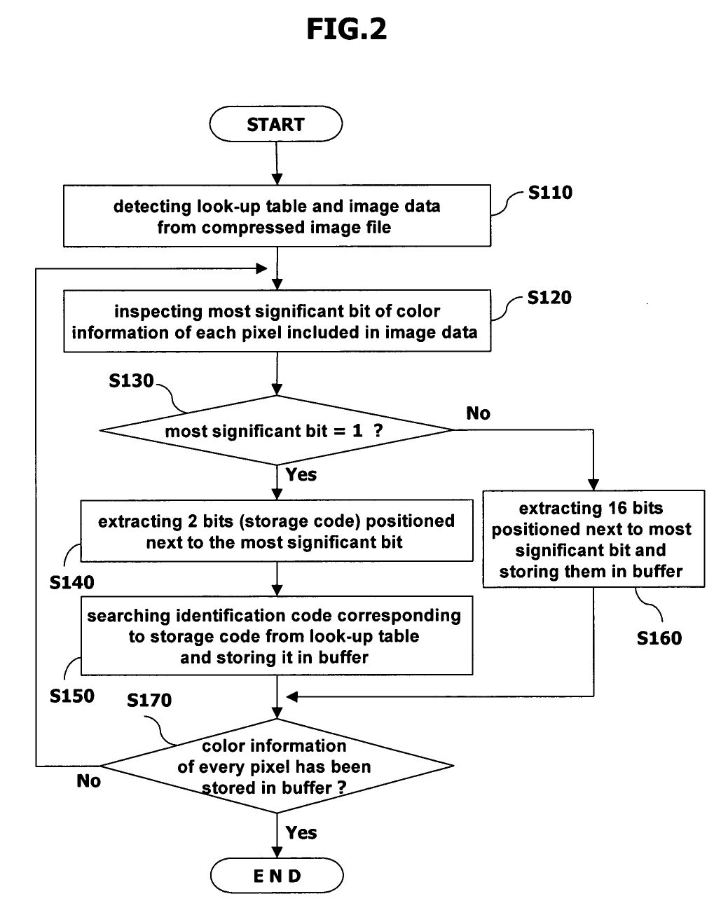

Referring to FIG. 2, a method for decompressing a compressed image in accordance with the present invention will now be described. First, a look-up table is detected from a compressed image file (S110). Data stored in the image file, namely, color information of each pixel, is decompressed with reference to the detected look-up table (S120˜S170).

In order to decompress the color information of each pixel, the mobile communication terminal checks whether an MSB (Most Significant Bit) of the color information of each pixel is 1 or 0 (S120). If the MSB is 1, then the bits (e.g., storage code) positioned next to the MSB are extracted (S140) and then an identification code (e.g., 16 bits corresponding to the extracted storage code) is searched from the look-up table and stored in the display buffer (S150).

If, however, the MSB is 0, the original identification code positioned next to the MSB is extracted and stored in the display buffer (S160). Through such processes (S120˜S160), the mobile communication decompresses the color information of each pixel. After the color information of every pixel constituting an image is stored in the display buffer (S170), colors of each pixel are displayed on the LCD with reference to the stored information.

As so far described, the method for compressing and decompressing an image of a mobile communication system in accordance with the present invention provides a compression rate for image data that is improved by newly assigning a specific identification code of a small size to a color with high presentation frequency. In addition, since the image compression algorithm is simply implemented, the amount of load and resources of a mobile communication required for compressing and decompressing an image.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A method for compressing an image in a mobile communication terminal, the method comprising:
scanning pixels constituting an image;
counting number of pixels of each color, each color associated with an original identification code;
assigning a first identification code of a size smaller than the original identification code to a first color presented in pixels greater than a first number;
assigning a second identification code to a second color presented in pixels smaller than the first number; and
storing the first identification code in association with color information for each pixel corresponding to the first color.

2. The method of claim 1, wherein the color information for each pixel corresponding to the first color comprises a code discrimination bit which indicates whether an identification code assigned to a corresponding color is the first identification code.

3. The method of claim 1, wherein the length of the first identification code is equivalent to a size for expressing colors presented in pixels greater than the first number.

4. The method of claim 1, wherein the image file comprises a look-up table enumerating colors presented in pixels greater than the first number and the first identification code assigned to each color.

5. The method of claim 1, wherein the image file comprises information about a length of the first identification code.

6. The method of claim 1, wherein the image file comprises information about a size of the look-up table.

7. The method of claim 1, wherein the first identification code is a new identification code.

8. The method of claim 1, wherein the second identification code is an original identification code.

9. A method for decompressing a compressed image of a mobile communication terminal comprising:
detecting a look-up table and color information of pixels from a compressed image file;
checking the color information of each pixel;
searching a corresponding original identification code from the look-up table and storing the color information in a display buffer if a color identification code of a corresponding pixel has been newly assigned; and
displaying color of each pixel on a screen with reference to the information stored in the buffer.

10. The method of claim 9, wherein the storing comprises:
checking a code discrimination bit included in color information of each pixel to determine whether a color identification code of a corresponding pixel is a new identification code or an origination identification code.

11. The method of claim 9, further comprising:
checking color information of each pixel, wherein if the color identification code is the original identification code of the corresponding pixel, the identification code is stored as is in the buffer.

12. The method of claim 9, wherein the color information of each pixel is stored including a code discrimination bit for indicating if an identification code assigned to a corresponding color is a new identification code or an original identification code.

13. The method of claim 12, wherein the code discrimination bit is an MSB (Most Significant Bit) of color information of each pixel.

14. The method of claim 9, wherein the look-up table comprises colors presented in pixels equal to or greater than a certain number and a new identification code assigned to each color.

15. The method of claim 9, wherein the image file comprises information on a length of a new identification code.

16. The method of claim 9, wherein the image file comprises information on a size of the look-up table.

17. The method of claim 9, wherein length of the newly assigned identification code is sufficient for expressing colors presented in pixels greater than a certain number.

18. An image compression method comprising:
counting number of pixels of at least a first color in an image comprising a plurality of pixels, wherein each of the plurality of pixels has a first identification code of a first size;
assigning a second identification code to pixels of at least the first color such that the second identification code is smaller in size than the first identification code, wherein number of pixels of at least the first color is greater than a first threshold.

19. The image compression method of claim 18, wherein at least the first identification code comprises an identifier distinguishing the first identification code from the second identification code.

20. The image compression method of claim 18, further comprising:
including a data structure comprising cross-references between the first and second identification codes and the plurality of pixels in the image.
